(19) United States
(12) Patent Application Publication
(10) Pub. No.: US 2025/0304037 A1
(43) Pub. Date: Oct. 2, 2025

(54) CONTROL SYSTEM AND CONTROL METHOD

(71) Applicant: HONDA MOTOR CO., LTD., Tokyo (JP)

(72) Inventors: Jumpei NOGUCHI, Tokyo (JP); Gaku Shimamoto, Tokyo (JP); Ayumu Mitomo, Tokyo (JP)

(73) Assignee: HONDA MOTOR CO., LTD., Tokyo (JP)

(21) Appl. No.: 19/059,301

(22) Filed: Feb. 21, 2025

(30) Foreign Application Priority Data
Mar. 29, 2024 (JP) 2024-055607

(51) Int. Cl. B60W 30/06; B60W 40/08; G05D 1/222; G05D 109/10; G05D 111/30

(52) U.S. Cl. CPC B60W 30/06; B60W 40/08; G05D 1/222; B60W 2040/0881; B60W 2540/043; B60W 2556/10; B60W 2556/45; G05D 2109/10; G05D 2111/30

(57) ABSTRACT

A system of a moving object includes a controller and an information terminal carriable by the user of the moving object. The controller is configured to execute first control for moving the moving object in a state where a user is present in the moving object; and execute second control for moving the moving object in a state where the user is not present in the moving object. In response to a first request, the controller executes first processing for determining execution authority of the user for the first control, and executes the first control based on a result of the first processing, and in response to a second request, the information terminal executes second processing for determining execution authority of the user for the second control, and causes the moving object to execute the second control based on a result of the second processing.

### CROSS-REFERENCE TO RELATED APPLICATIONS

This application is based on and claims priority under 35 USC 119 from Japanese Patent Application No. 2024-055607 filed on Mar. 29, 2024, the contents of which are incorporated herein by reference.

### TECHNICAL FIELD

The present disclosure relates to a control system and a control method.

### BACKGROUND

In recent years, efforts have been made to provide access to a sustainable transportation system in consideration of people vulnerable among traffic participants. In order to implement the above, focus has been placed on research and development for further improving safety and convenience of traffic by research and development related to self-driving techniques.

In the related art, there is known a remote parking system that remotely operates a vehicle using a smartphone to park the vehicle in a specified predetermined parking space or to cause the vehicle to exit from the parking space. There is also known a function-on-demand (FOD) system in which a target function of a vehicle is enabled according to contract status (settlement management) of a user.

For example, Japanese Patent Publication No. 6354541B (hereinafter, referred to as Patent Literature 1) discloses a vehicle remote operation system including an electronic key that is registered in advance as a device capable of remotely operating a vehicle, a mobile communication device that is registered in advance as a property of a user of the vehicle, an in-vehicle authentication unit that is mounted on the vehicle to determine whether authentication of the electronic key and the mobile communication device is successful, and a permission determination unit that permits self-driving control for causing the vehicle to automatically travel to a position of the user based on determination in the in-vehicle authentication unit that the authentication of the electronic key and the mobile communication device is successful.

Japanese Patent Application Laid-Open Publication No. 2016-529767A (hereinafter, referred to as Patent Literature 2) discloses a method for acquiring a signal of a vehicle using a signal receiving unit provided in a mobile control unit, which is a method for remotely controlling a function of the vehicle to perform remote control for a predetermined time after an authentication signal recognized to be effective by the vehicle is acquired only when a visual signal or an audible signal is generated at a predetermined position of the vehicle and the visual signal or the audible signal is acquired by the signal receiving unit.

In the FOD system, for example, a target function is enabled by operating a navigation screen or executing personal authentication with a driver monitor camera. Therefore, in the case of a remote parking system that can remotely operate a vehicle using a smartphone, when a user starts a remote operation outside the vehicle, personal authentication inside the vehicle cannot be executed (which is troublesome). In this case, a method of transmitting information on the smartphone to the vehicle through communication to execute the personal authentication on the vehicle side is conceivable. However, in this method, since the personal authentication is executed through communication between the smartphone and the vehicle, it may be time-consuming until the personal authentication is completed, or there may be a risk of information leakage due to transmission and reception of personal information. Patent Literatures 1 and 2 do not disclose authentication of a user in cases where the user is inside the vehicle and outside the vehicle, nor enabling of a remote function based on the authentication.

The present disclosure relates to providing a control system and a control method that can appropriately determine execution authority of a user for a target function of a vehicle. This contributes to development of a sustainable transportation system.

### SUMMARY

A first aspect of the present disclosure relates to a control system including:
a control device provided in a moving object; and
an information terminal carriable by a user of the moving object, in which the control device includes:
a first movement controller configured to execute first movement control for moving the moving object in a state where the user is present in the moving object; and
a second movement controller configured to second movement control for moving the moving object in a state where the user is not present in the moving object,
in response to a request to execute the first movement control from the user, the first movement controller executes first determination processing for determining execution authority of the user for the first movement control, and executes the first movement control based on a result of the first determination processing, and
in response to a request to execute the second movement control from the user, the information terminal executes second determination processing for determining execution authority of the user for the second movement control, and causes the control device to execute the second movement control based on a result of the second determination processing.

A second aspect of the present disclosure relates to a control method in a control system that includes a control device provided in a moving object and an information terminal carriable by a user of the moving object, in which
the control device includes:
a first movement controller that executes first movement control for moving the moving object in a state where the user is present in the moving object; and
a second movement controller that executes second movement control for moving the moving object in a state where the user is not present in the moving object, and
the control method includes:
causing, when a request to execute the first movement control is received from the user, the first movement controller to execute first determination processing for determining execution authority of the user for the first movement control and to execute the first movement control based on a result of the first determination processing; and
causing, when a request to execute the second movement control is received from the user, the information terminal to execute second determination processing for determining execution authority of the user for the second movement control and to cause the control device to execute the second movement control based on a result of the second determination processing.

According to the present disclosure, it is possible to provide a control system and a control method that can appropriately determine execution authority of a user for a target function of a vehicle.

### BRIEF DESCRIPTION OF DRAWINGS

Exemplary embodiments of the present disclosure will be described in detail based on the following figures, wherein:

FIG. 1 is a side view showing an example of a vehicle 10 where a control device in a control system in the present disclosure is mounted;

FIG. 2 is a top view of the vehicle 10 shown in FIG. 1;

FIG. 3 is a block diagram showing an example of an internal configuration of the vehicle 10 shown in FIG. 1;

FIG. 4 shows an example of a control system 1 in the present disclosure;

FIG. 5 shows an example of a hardware configuration of an information terminal 60 owned by a user U1 of the vehicle 10;

FIG. 6 is a sequence diagram showing an example of first movement control for moving the vehicle 10 in a state where the user U1 is present in the vehicle 10;

FIG. 7 is a sequence diagram showing a case where the user U1 does not have execution authority for automated parking in the first movement control in FIG. 6;

FIG. 8 shows an example of a message screen displayed during the first movement control;

FIG. 9 shows an example of a state where movement control of the vehicle 10 is executed from outside the vehicle 10 using the information terminal 60;

FIG. 10 is a sequence diagram showing an example of second determination processing during remote parking;

FIG. 11 is a sequence diagram showing an example of remote parking control executed based on a result of the second determination processing;

FIG. 12 shows an example of a disclaimer screen 72 displayed on a terminal screen 71 on the information terminal 60;

FIG. 13 shows an example of a power start-up screen 73 displayed on the terminal screen 71 on the information terminal 60;

FIG. 14 shows an example of an execution instruction reception screen 74 displayed on the terminal screen 71 on the information terminal 60;

FIG. 15 is a sequence diagram showing a case where the user U1 does not have execution authority for remote parking in the second determination processing in FIG. 10; and

FIG. 16 shows an example of a message screen displayed during second movement control.

### DESCRIPTION OF EMBODIMENTS

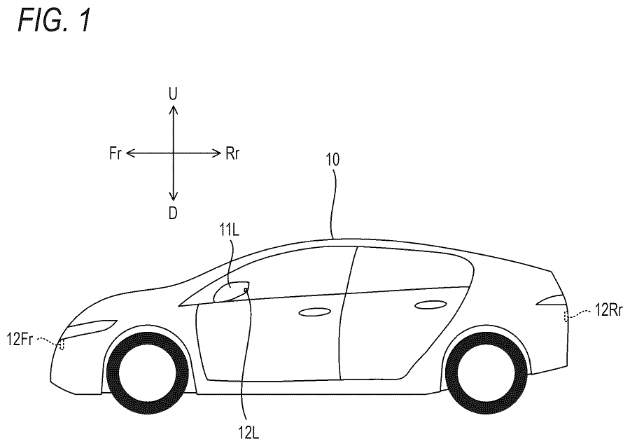

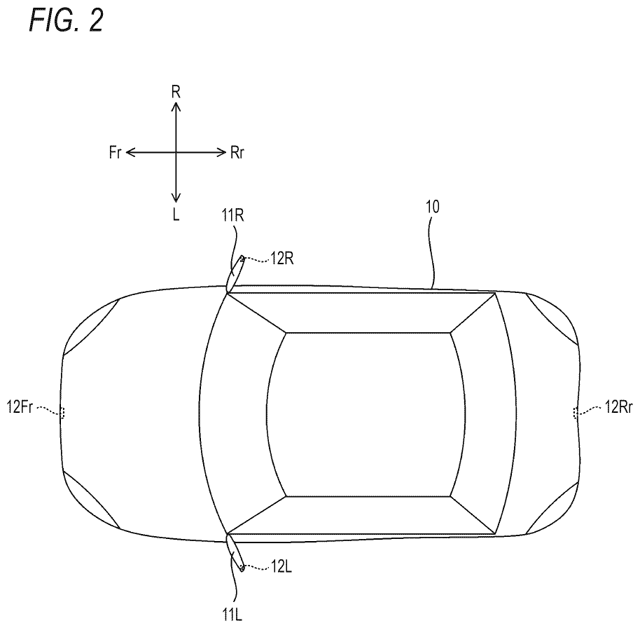

Hereinafter, an embodiment of a control system and a control method in the present disclosure will be described with reference to the accompanying drawings. The drawings are viewed in directions of reference numerals. In order to simplify and clarify the description in the present specification or the like, a front-rear direction, a left-right direction, and an upper-lower direction are described according to directions viewed from a driver of a vehicle 10 shown in FIGS. 1 and 2. In the drawings, a front side of the vehicle 10 is shown as Fr, a rear side is shown as Rr, a left side is shown as L, a right side is shown as R, an upper side is shown as U, and a lower side is shown as D.

### Configuration of Vehicle 10

FIG. 1 is a side view showing an example of the vehicle 10 where a control device in the control system in the present disclosure is mounted. FIG. 2 is a top view of the vehicle 10 shown in FIG. 1. The vehicle 10 is an example of a “moving object” in the present disclosure.

The vehicle 10 is an automobile including a drive source (not shown) and wheels including drive wheels driven by power of the drive source and steerable steered wheels. In the present embodiment, the vehicle 10 is a four-wheeled automobile including a pair of left and right front wheels and a pair of left and right rear wheels. The drive source of the vehicle 10 is, for example, an electric motor. The drive source of the vehicle 10 may be an internal combustion engine such as a gasoline engine or a diesel engine, or a combination of an electric motor and an internal combustion engine. The drive source of the vehicle 10 may drive the pair of left and right front wheels, the pair of left and right rear wheels, or four wheels including the pair of left and right front wheels and the pair of left and right rear wheels. The front wheels and the rear wheels may all be steerable steered wheels, or the front wheels or the rear wheels may be steerable steered wheels.

The vehicle 10 further includes side mirrors 11L and 11R. The side mirrors 11L and 11R are mirrors (back mirrors) provided on outer sides of front seat doors of the vehicle 10 for the driver to check the rear side and rear lateral sides. The side mirrors 11L and 11R are fixed to a body of the vehicle 10 by rotation shafts extending in a vertical direction, and may be opened and closed by rotating about the rotation shafts.

The vehicle 10 further includes a front camera 12Fr, a rear camera 12Rr, a left side camera 12L, and a right side camera 12R. The front camera 12Fr is an imaging device (for example, a digital camera) that is provided on the front side of the vehicle 10 and captures an image in a forward direction of the vehicle 10. The rear camera 12Rr is a digital camera that is provided on the rear side of the vehicle 10 and captures an image in a rearward direction of the vehicle 10. The left side camera 12L is a digital camera that is provided on the left side mirror 11L of the vehicle 10 and captures an image in a leftward direction of the vehicle 10. The right side camera 12R is a digital camera that is provided on the right side mirror 11R of the vehicle 10 and captures an image in a rightward direction of the vehicle 10.

### Internal Configuration of Vehicle 10

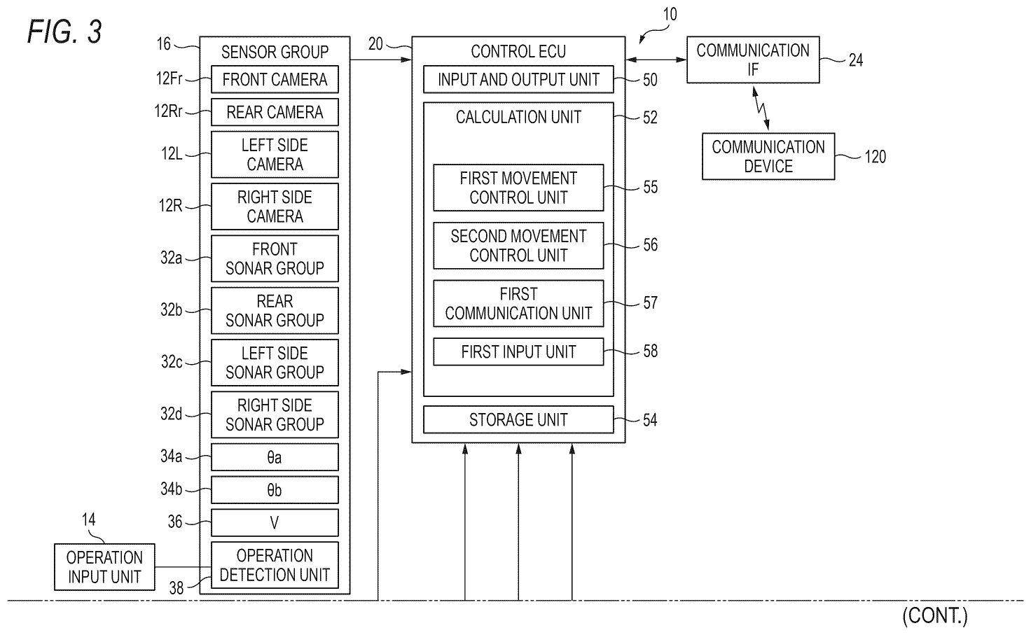

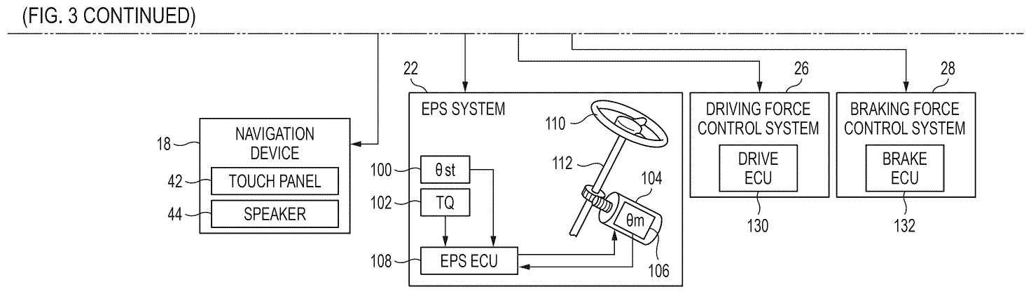

FIG. 3 is a block diagram showing an example of an internal configuration of the vehicle 10 shown in FIG. 1. As shown in FIG. 3, the vehicle 10 includes a sensor group 16, a navigation device 18, a control electronic control unit (ECU) 20, an electric power steering (EPS) system 22, and a communication IF 24. The vehicle 10 further includes a driving force control system 26 and a braking force control system 28.

The sensor group 16 acquires various detection values used for control by the control ECU 20. The sensor group 16 includes the front camera 12Fr, the rear camera 12Rr, the left side camera 12L, and the right side camera 12R. The sensor group 16 also includes a front sonar group 32a, a rear sonar group 32b, a left side sonar group 32c, and a right side sonar group 32d. The sensor group 16 also includes wheel sensors 34a and 34b, a vehicle speed sensor 36, and an operation detection unit 38.

The front camera 12Fr, the rear camera 12Rr, the left side camera 12L, and the right side camera 12R acquire recognition data (for example, peripheral images) for recognizing an external environment of the vehicle 10 by capturing images of a periphery of the vehicle 10. The peripheral images of the vehicle 10 captured by the front camera 12Fr, the rear camera 12Rr, the left side camera 12L, and the right side camera 12R are referred to as a front image, a rear image, a left side image, and a right side image, respectively. An image constituted by the left side image and the right side image may be referred to as a side image. An image of the vehicle 10 and the periphery of the vehicle, which is generated by combining captured images from the front camera 12Fr, the rear camera 12Rr, the left side camera 12L, and the right side camera 12R, is referred to as a top view image of the vehicle 10.

The front sonar group 32a, the rear sonar group 32b, the left side sonar group 32c, and the right side sonar group 32d emit sound waves to the periphery of the vehicle 10 and receive reflected sounds from other objects. The front sonar group 32a includes, for example, four sonars. The sonars that constitute the front sonar group 32a are respectively provided on an obliquely left front side, a front left side, a front right side, and an obliquely right front side of the vehicle 10. The rear sonar group 32b includes, for example, four sonars. The sonars that constitute the rear sonar group 32b are respectively provided on an obliquely left rear side, a rear left side, a rear right side, and an obliquely right rear side of the vehicle 10. The left side sonar group 32c includes, for example, two sonars. The sonars that constitute the left side sonar group 32c are provided at a left side front portion and a left side rear portion of the vehicle 10, respectively. The right side sonar group 32d includes, for example, two sonars. The sonars that constitute the right side sonar group 32d are provided at a right side front portion and a right side rear portion of the vehicle 10, respectively.

The wheel sensors 34a and 34b detect rotation angles of the wheels of the vehicle 10. The wheel sensors 34a and 34b may be implemented by angle sensors or displacement sensors. The wheel sensors 34a and 34b output detection pulses each time the wheels rotate by a predetermined angle. The detection pulses output from the wheel sensors 34a and 34b are used to calculate rotation angles and rotation speeds of the wheels. A movement distance of the vehicle 10 is calculated based on the rotation angles of the wheels. The wheel sensor 34a detects, for example, a rotation angle θa of the left rear wheel. The wheel sensor 34b detects, for example, a rotation angle θb of the right rear wheel.

The vehicle speed sensor 36 detects a speed of a vehicle body of the vehicle 10, that is, a vehicle speed V, and outputs the detected vehicle speed V to the control ECU 20. The vehicle speed sensor 36 detects the vehicle speed V based on, for example, rotation of a transmission countershaft.

The operation detection unit 38 detects an operation content of a user performed using an operation input unit 14, and outputs the detected operation content to the control ECU 20. The operation input unit 14 includes various user interfaces such as a side mirror switch that switches between opened and closed states of the side mirrors 11L and 11R, and a shift lever (a selector lever or a selector).

The navigation device 18 detects a current position of the vehicle 10 by using, for example, a global positioning system (GPS), and guides the user along a path to a destination. The navigation device 18 includes a storage device (not shown) provided with a map information database.

The navigation device 18 includes a touch panel 42 and a speaker 44. The touch panel 42 functions as an input device and a display device of the control ECU 20. The speaker 44 outputs various types of guide information to the user of the vehicle 10 by voice.

The touch panel 42 enables input of various commands to the control ECU 20. For example, the user may input a command related to movement assistance of the vehicle 10 via the touch panel 42. The movement assistance includes parking assistance and exiting assistance of the vehicle 10. The touch panel 42 displays various screens related to control contents of the control ECU 20. For example, the touch panel 42 displays a screen related to the movement assistance of the vehicle 10. Specifically, the touch panel 42 displays a parking assistance button for requesting parking assistance of the vehicle 10 and an exiting assistance button for requesting exiting assistance. The parking assistance button includes an automated parking button for requesting parking by automated steering of the control ECU 20, and a support parking button for requesting support while parking the vehicle by an operation of the user. The exiting assistance button includes an automated exiting button for requesting exiting by the automated steering of the control ECU 20, and a support exiting button for requesting support while exiting by an operation of the user. A constituent element other than the touch panel 42, for example, an information terminal such as a smartphone or a tablet may be used as the input device or the display device.

The control ECU 20 includes an input and output unit 50, a calculation unit 52, and a storage unit 54. The calculation unit 52 is implemented by, for example, a central processing unit (CPU). The calculation unit 52 executes various types of control by controlling units based on a program stored in the storage unit 54. The calculation unit 52 also receives and outputs signals from and to units connected to the control ECU 20 via the input and output unit 50.

The calculation unit 52 includes a first movement control unit 55, a second movement control unit 56, a first communication unit 57, and a first input unit 58. The calculation unit 52 is an example of a “control device” in the present disclosure.

The first movement control unit 55 executes first movement control for moving the vehicle 10 in a state where the user is present in the vehicle 10. Upon receiving a first execution request for requesting execution of the first movement control from the user, the first movement control unit 55 executes first determination processing for determining execution authority of the user for the first movement control. The first movement control unit 55 executes the first movement control based on a result of the first determination processing. The “first movement control” is movement control of the vehicle 10 from inside the vehicle using an automated parking system (APS) in the present embodiment. The “determination processing” is processing of authenticating the user (specifying a person) and determining whether the user has execution authority for a function of the movement control, and is, for example, processing of communicating with an external server and querying the server.

The second movement control unit 56 executes second movement control through which the vehicle 10 can be moved in a state where the user is not present in the vehicle 10. The “second movement control” is movement control of the vehicle 10 from outside the vehicle using a remote parking system (RPS) in the present embodiment. The second movement control unit 56 receives a movement control execution instruction from outside the vehicle 10 by communicating with an information terminal carried by the user of the vehicle 10 via the communication IF 24, for example.

The first communication unit 57 is a communication unit that can communicate with, for example, an external first server. The first server is a server that manages license information of the vehicle 10. The first server may be a physical server or a virtual server.

The first input unit 58 is an input unit where a first execution instruction of the first movement control can be received. The first input unit 58 may be, for example, the touch panel 42 of the navigation device 18, an in-vehicle camera (driver monitoring camera) that captures an image of the user in the vehicle, or APS-SW. The SW may be a mechanical switch of a press type, a slide type, or the like, a capacitive switch, a button displayed on the touch panel, or the like.

When the execution authority of the user for the first movement control is determined to be valid through the first determination processing, the first movement control unit 55 controls a state of the first input unit 58 to a state where the execution instruction of the first movement control is received. When the execution authority of the user for the first movement control is not determined to be valid through the first determination processing, the first movement control unit 55 controls the state of the first input unit 58 to a state where the execution instruction of the first movement control is not received. The first movement control unit 55 queries the first server via the first communication unit 57 to execute the first determination processing.

The first movement control unit 55 executes automated parking assistance and automated exiting assistance of the vehicle 10 through automated steering in which a steering 110 is operated in an automated manner under control of the first movement control unit 55. In the automated parking assistance and the automated exiting assistance, an accelerator pedal (not shown), a brake pedal (not shown), and the operation input unit 14 are operated in an automated manner. The first movement control unit 55 executes support parking assistance and support exiting assistance when the user (driver) operates the accelerator pedal, the brake pedal, and the operation input unit 14 to perform manual parking and manual exiting of the vehicle 10.

For example, the first movement control unit 55 executes movement control for executing movement of the vehicle 10 based on the recognition data of the external environment of the vehicle 10 acquired by the front camera 12Fr, the rear camera 12Rr, the left side camera 12L, and the right side camera 12R, and a predetermined parking space specified by the user. The movement control includes parking control for parking the vehicle 10 in the predetermined parking space (target parking position) in an automated manner and exiting control for causing the vehicle 10 to exit from the predetermined parking space to a user summon position (target exit position) in an automated manner.

The second movement control unit 56 executes remote parking assistance and remote exiting assistance of the vehicle 10 through automated steering in which the steering 110 is operated in an automated fashion under control of the second movement control unit 56. In the remote parking assistance and the remote exiting assistance, the accelerator pedal (not shown), the brake pedal (not shown), and the operation input unit 14 are operated in an automated manner. The second movement control unit 56 executes support parking assistance and support exiting assistance when the user (driver) operates the accelerator pedal, the brake pedal, and the operation input unit 14 to perform manual parking and manual exiting of the vehicle 10. At the time of the remote parking assistance and the remote exiting assistance, the user may be in a state of getting off the vehicle 10 and being outside (non-occupant state), or may be in a state of being present in the vehicle 10.

For example, the second movement control unit 56 executes movement control for executing movement of the vehicle 10 based on the recognition data of the external environment of the vehicle 10 acquired by the front camera 12Fr, the rear camera 12Rr, the left side camera 12L, and the right side camera 12R, and the predetermined parking space specified by the user. The movement control includes parking control for remotely parking the vehicle 10 in the predetermined parking space (target parking position) and exiting control for remotely causing the vehicle 10 to exit from the predetermined parking space to the user summon position (target exit position). The second movement control unit 56 may execute the parking control and the exiting control according to an execution instruction signal received from the outside via the communication IF 24. Input from the outside includes input through wireless communication from an information terminal 60 or the like carried by the user of the vehicle 10. The second movement control unit 56 may transmit information about the parking control and the exiting control to the external information terminal 60 via the communication IF 24.

The first movement control unit 55 and the second movement control unit 56 register the predetermined parking space specified by the user in the storage unit 54 as a specified parking space. The first movement control unit 55 and the second movement control unit 56 register a feature related to the specified parking space in the storage unit 54 based on the recognition data of the external environment of the vehicle 10 acquired by the front camera 12Fr, the rear camera 12Rr, the left side camera 12L, and the right side camera 12R. The first movement control unit 55 and the second movement control unit 56 execute the parking control for parking the vehicle 10 in the specified parking space and the exiting control for exiting from the specified parking space based on the recognition data of the external environment of the vehicle 10 and the feature of the specified parking space specified by the user.

The EPS system 22 includes a steering angle sensor 100, a torque sensor 102, an EPS motor 104, a resolver 106, and an EPS ECU 108. The steering angle sensor 100 detects a steering angle θst of the steering 110. The torque sensor 102 detects a torque TQ applied to the steering 110.

The EPS motor 104 applies a driving force or a reaction force to a steering column 112 coupled to the steering 110, thereby providing support for an occupant's operation on the steering 110 and automated steering during the parking assistance. The resolver 106 detects a rotation angle Om of the EPS motor 104. The EPS ECU 108 controls the entire EPS system 22. The EPS ECU 108 includes an input and output unit (not shown), a calculation unit (not shown), and a storage unit (not shown).

The communication IF 24 enables wireless communication with another communication device 120. The other communication device 120 includes a base station, a communication device of another vehicle, an external server, or an information terminal such as a smartphone or a tablet carried by the user of the vehicle 10. For example, the communication IF 24 includes an ultra wide band (UWB, registered trademark) interface or the like that can execute UWB communication. Examples of the wireless communication with the information terminal 60 include, in addition to UWB communication, Bluetooth low energy (BLE: registered trademark), and near field communication (NFC: registered trademark).

The driving force control system 26 includes a drive ECU 130. The driving force control system 26 executes driving force control of the vehicle 10. The drive ECU 130 controls a driving force of the vehicle 10 by controlling an engine (not shown) or the like based on an operation performed by the user on the accelerator pedal (not shown).

The braking force control system 28 includes a brake ECU 132. The braking force control system 28 executes braking force control of the vehicle 10. The brake ECU 132 controls a braking force of the vehicle 10 by controlling a brake mechanism or the like (not shown) based on an operation performed by the user on the brake pedal (not shown).

### Control System in Present Disclosure

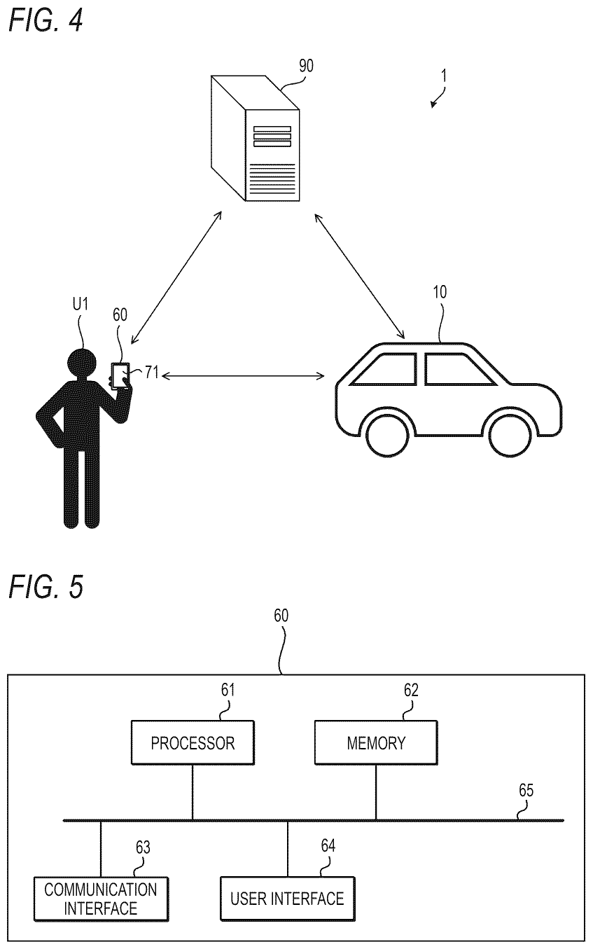

FIG. 4 shows an example of a control system 1 in the present disclosure. As shown in FIG. 4, the control system 1 includes a server 90 that is an example of a “first server” and a “second server” in the present disclosure, and the vehicle 10 and the information terminal 60 that can communicate with the server 90. One vehicle 10 is shown in this example, and the number of vehicles may be plural.

The server 90 is an external server provided at a facility such as a management center. The server 90 manages authority information related to the execution authority of the vehicle 10, which is acquired when a user U1 uses the vehicle 10, in association with the user U1 (user ID). Software for executing the movement control of the vehicle 10 described above is managed by this server 90. Use of the software is one piece of the authority information related to the execution authority of the vehicle 10. The user can download the software from this server 90. The control system 1 is, for example, a function-on-demand (FOD) system.

The server 90 executes control to enable and disable (turn on and off) a function of the vehicle 10 when the user uses the vehicle 10. Specifically, the server 90 executes control to switch between enabling and disabling of the function in the vehicle 10 by transmitting, to the vehicle 10, a function ON signal for enabling the function or a function OFF signal for disabling the function.

The information terminal 60 is, for example, a smartphone or a tablet owned by the user. After purchasing the vehicle 10, for example, the user purchases, using the information terminal 60, execution authority for a predetermined function of the vehicle 10 online. The user can use the purchased function in the vehicle 10 by transmitting an execution authority ID acquired by the purchase from the information terminal 60 to the server 90.

The vehicle 10 is a vehicle that can execute so-called self-driving or assisted driving. Self-driving control includes the first movement control using APS and the second movement control using RPS described above. The vehicle 10 may be a vehicle whose user is limited, such as a vehicle owned by an individual, or a vehicle whose user is not limited, such as a vehicle owned by a corporation. Those who can use a vehicle owned by an individual include, for example, an owner of the vehicle, and family members, relatives, and friends thereof. The vehicle owned by a corporation includes a vehicle available to an unspecified number of users under a predetermined contract, such as a rental car or a shared car.

### Hardware Configuration of Information Terminal 60

FIG. 5 shows an example of a hardware configuration of the information terminal 60 owned by the user U1 of the vehicle 10. The information terminal 60 includes a processor 61, a memory 62, a communication interface 63, and a user interface 64. The processor 61, the memory 62, the communication interface 63, and the user interface 64 are connected by, for example, a bus 65.

The processor 61 is a circuit that executes signal processing, and is, for example, a central processing unit (CPU) that controls the entire information terminal 60. The processor 61 may be implemented by another digital circuit such as a field programmable gate array (FPGA) or a digital signal processor (DSP). The processor 61 may also be implemented by combining a plurality of digital circuits.

The memory 62 includes, for example, a main memory and an auxiliary memory. The main memory is, for example, a random access memory (RAM). The main memory is used as a work area of the processor 61.

The auxiliary memory is a non-volatile memory such as a magnetic disk, an optical disk, or a flash memory. The auxiliary memory stores various programs for operating the information terminal 60. The programs stored in the auxiliary memory are loaded into the main memory and executed by the processor 61.

The auxiliary memory may include a portable memory removable from the information terminal 60. Examples of the portable memory include a universal serial bus (USB) flash drive, a memory card such as a secure digital (SD) memory card, and an external hard disk drive.

The communication interface 63 is a communication interface that executes wireless communication with the outside of the information terminal 60 (for example, the communication IF 24 of the vehicle 10). For example, the communication interface 63 includes a UWB interface for executing UWB communication with the vehicle 10. The communication interface 63 is controlled by the processor 61.

The user interface 64 includes, for example, an input device that receives an operation input from the user U1 and an output device that outputs information to the user U1. The input device may be implemented by, for example, a touch panel. The output device may be implemented by, for example, a display or a speaker. The user interface 64 is controlled by the processor 61.

The processor 61 executes movement control for instructing movement of the vehicle 10. For example, the processor 61 instructs the vehicle 10 to execute the movement control (including parking control and exiting control) based on a specific operation of the user U1 on a terminal screen 71 (see FIG. 4) of the information terminal 60. The specific operation includes, for example, a slide operation for moving the vehicle 10, and a tap operation for reserving parking and exiting plans. The slide operation includes a continuous position instruction operation (for example, a swipe operation), a rotation instruction operation in a predetermined rotation direction (for example, a rotation swipe operation), and the like. The processor 61 further executes control to generate a guidance image for prompting the user U1 to perform an instruction operation on the terminal screen of the information terminal 60 and display the generated guidance image on the terminal screen.

Upon receiving a second execution request for requesting execution of the second movement control from the user U1, the processor 61 executes second determination processing for determining execution authority of the user U1 for the second movement control. The processor 61 causes the second movement control unit 56 of the vehicle 10 to execute the second movement control based on a result of the second determination processing. The “second determination processing” is determination processing executed without going through the second movement control unit 56 of the vehicle 10. That is, the second determination processing is determination processing executed by causing the processor 61 of the information terminal 60 to communicate with the server 90 without going through the calculation unit 52 of the vehicle 10 to query about the execution authority of the user U1. “Causing the vehicle 10 to execute the second movement control” means, for example, to cause the vehicle 10 to move by transmitting a movement instruction signal to the vehicle 10 in response to reception of a rotation swipe operation on the terminal screen 71.

When it is determined that the execution authority of the user U1 for the second movement control is valid through the second determination processing, the processor 61 controls a state of a touch panel on the terminal screen 71 to a state where the execution instruction of the second movement control is received. When it is determined that the execution authority of the user U1 for the second movement control is not valid through the second determination processing, the processor 61 controls the state of the touch panel on the terminal screen 71 to a state where the execution instruction of the second movement control is not received. The terminal screen 71 on the information terminal 60 is an input unit where a second execution instruction of the second movement control can be received, and is an example of a “second input unit” in the present disclosure.

The processor 61 executes the second determination processing by querying the server 90 that is an example of the second server via the communication interface 63. The processor 61 and the communication interface 63 are a communication unit that can communicate with the second server, and are an example of a “second communication unit” in the present disclosure. The second server may be the same as or different from the first server. The second server may be a physical server or a virtual server. The processor 61 and the user interface 64 are a communication unit that can communicate with the terminal screen 71, and are an example of the “second communication unit” in the present disclosure.

When communication with the second server is not available, the processor 61 causes the second movement control unit 56 of the vehicle 10 to execute the second movement control based on a result of second determination processing in the past stored in the memory 62. For example, in a case where a radio wave cannot reach the server 90, such as underground (out of range), personal authentication may be executed using a latest history stored in the information terminal 60. The “result of the second determination processing in the past” stored in the memory 62 may be provided with an expiration date before which the result is usable in personal authentication. The memory 62 is an example of a “storage unit” in the present disclosure.

The processor 61 transmits, to the vehicle 10, a parking instruction for remotely parking the vehicle 10 and an exiting instruction for remotely causing the vehicle 10 to exit based on a specific operation on the terminal screen 71 of the information terminal 60. An application that can execute the movement control of the vehicle 10 by transmitting and receiving information related to the movement control of the vehicle 10 to and from the vehicle 10 is installed in the information terminal 60.

### Automatic Movement Control by Vehicle 10

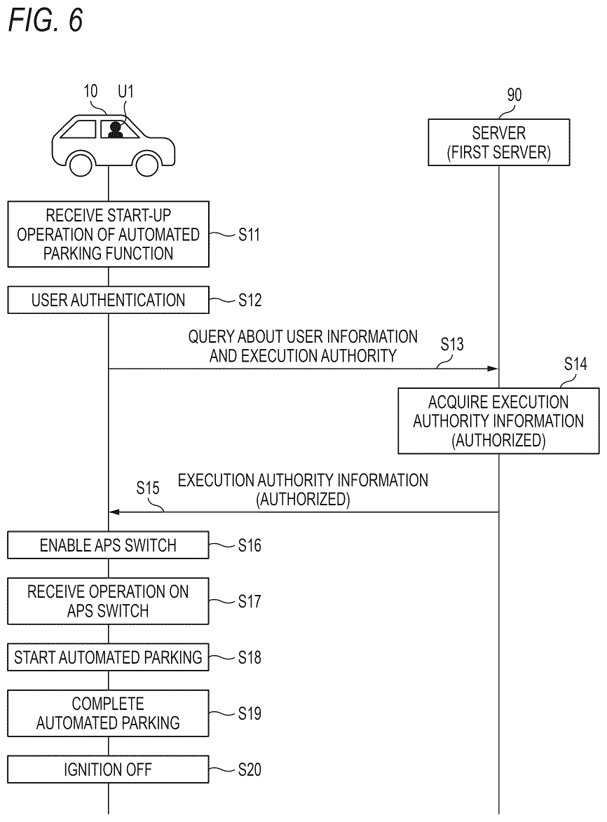

FIG. 6 is a sequence diagram showing an example of the first movement control for moving the vehicle 10 in a state where the user U1 is present in the vehicle 10. The first movement control in this example is an example of parking control when the vehicle 10 is automatically parked.

First, as shown in FIG. 6, the vehicle 10 receives a start-up operation of an automated parking function (step S11). The start-up operation of the automated parking function is the first execution request of automated parking (first movement control) from the user, and is, for example, a tap operation on a “parking assistance button” displayed on the touch panel 42 of the navigation device 18.

Next, the vehicle 10 executes user authentication for the user U1 (step S12). For example, the user authentication may be implemented by inputting the user ID to the touch panel 42 or facial authentication through camera imaging. The vehicle 10 transmits, to the server 90 (first server), user information collected in the user authentication and a query about whether the user has the execution authority for the first movement control (step S13).

Upon receiving the query about the execution authority of the user U1, the server 90 acquires execution authority information managed in association with the user ID, for example (step S14). In this example, it is assumed that the user U1 has the execution authority for the automated parking of the vehicle 10. The server 90 transmits, to the vehicle 10, the execution authority information indicating that the user U1 has the execution authority for the automated parking of the vehicle 10 (authorized) (step S15).

Upon receiving the execution authority information (authorized) from the server 90 in step S15, the vehicle 10 enables an “APS switch” for receiving the execution instruction of the first movement control using the APS, and lights and displays a button of the “APS switch” on the touch panel 42, for example (step S16). When the user U1 touches the button of the “APS switch” on the touch panel 42, the vehicle 10 receives the operation on the APS switch (step S17).

Next, the vehicle 10 starts the automated parking of the vehicle 10 based on the recognition data of the external environment acquired by each camera and the specified parking space (step S18). When the automated parking is completed (step S19), the vehicle 10 turns off the ignition (step S20).

The user authentication in step S12 may be executed in advance, for example, at the start of driving of the vehicle 10. In the first movement control in this example, the control for parking the vehicle 10 in an automated manner has been described, but the first movement control is not limited thereto. For example, the first movement control may be control for causing the vehicle 10 to exit in an automated manner. In the case of automated exiting, the ignition may not be turned off after the automated exiting is completed.

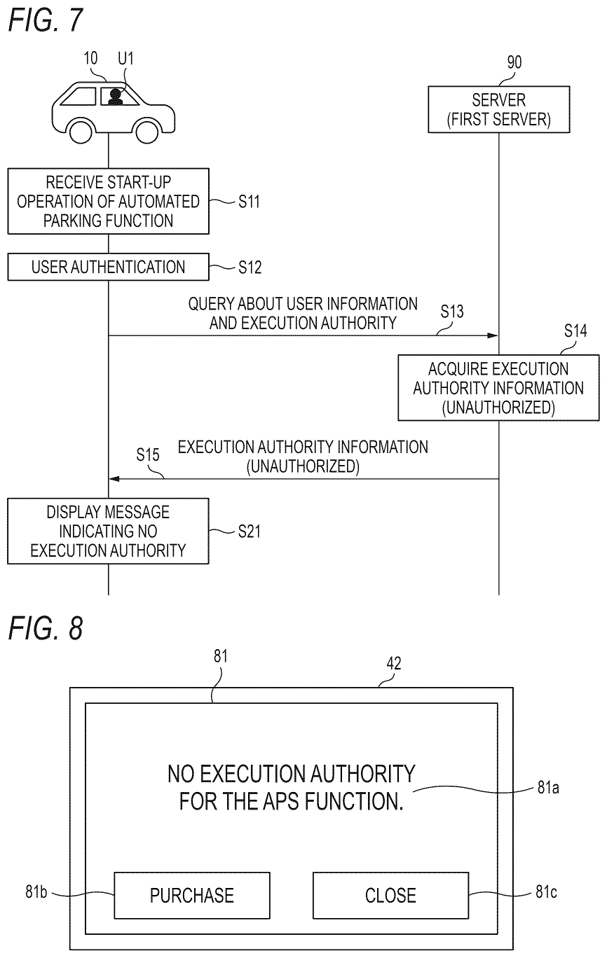

FIG. 7 is a sequence diagram showing a case where the user U1 does not have the execution authority for the automated parking in the first movement control in FIG. 6. As shown in FIG. 7, the processing from step S11 to step S13 is the same as that from step S11 to step S13 described with reference to FIG. 6.

Upon receiving the query about the execution authority of the user U1 in step S13, the server 90 acquires the execution authority information managed in association with the user ID (step S14). In this example, the user U1 does not have the execution authority for the automated parking of the vehicle 10 (unauthorized). The server 90 transmits, to the vehicle 10, the execution authority information indicating that the user U1 does not have the execution authority for the automated parking of the vehicle 10 (unauthorized) (step S15).

Upon receiving the execution authority information (unauthorized) from the server 90 in step S15, the vehicle 10 displays a message indicating that there is no execution authority on the touch panel 42 (step S21).

The first movement control is not limited to the control for automatically parking the vehicle 10, and may be control for causing the vehicle 10 to automatically exit.

### Message During First Movement Control

FIG. 8 shows an example of a message screen displayed during the first movement control. The message screen in this example is a screen displayed on the touch panel 42 when the user U1 does not have the execution authority for the automated parking in step S21 in the first movement control in FIG. 7.

As shown in FIG. 8, a message screen 81 displays an execution authority message 81a indicating that there is no execution authority, such as “NO EXECUTION AUTHORITY FOR THE APS FUNCTION”. The message screen 81 also includes a “PURCHASE” button 81b for purchasing the execution authority for the APS function online, and a “CLOSE” button 81c for stopping the present operation for parking the vehicle 10 in an automated manner.

### Remote Movement Control Using Information Terminal 60

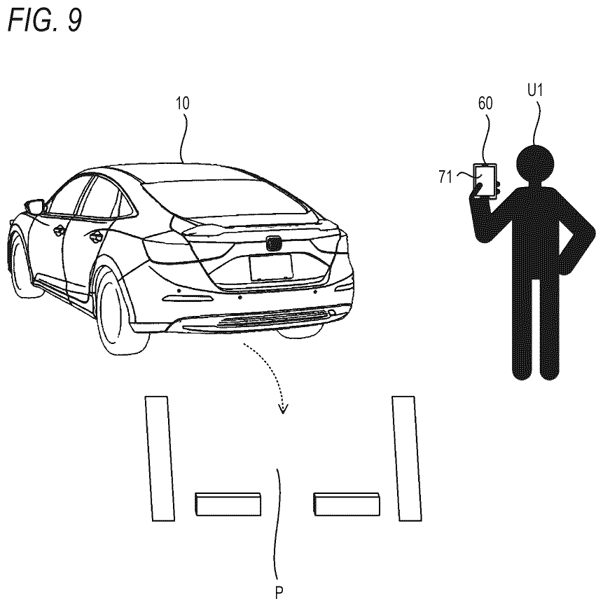

Next, remote movement control of the vehicle 10 using the information terminal 60 will be described with reference to FIGS. 9 to 16.

FIG. 9 shows an example of a state where the movement control of the vehicle 10 is executed from outside the vehicle 10 using the information terminal 60. In a state where the user U1 of the vehicle 10 is not present in the vehicle 10, the user U1 issues an execution instruction of the second movement control for remotely parking the vehicle 10 in a parking space P (parking instruction) using the information terminal 60 owned by the user U1. In this example, remote parking is described, and the same applies to, for example, an exiting instruction to remotely cause the vehicle 10 to exit from the parking space P.

Upon receiving the second execution request of the second movement control from the user U1, the information terminal 60 executes the second determination processing for determining whether the user U1 has the execution authority for the second movement control with the server 90, and causes the vehicle 10 to execute the second movement control based on a result of the second determination processing.

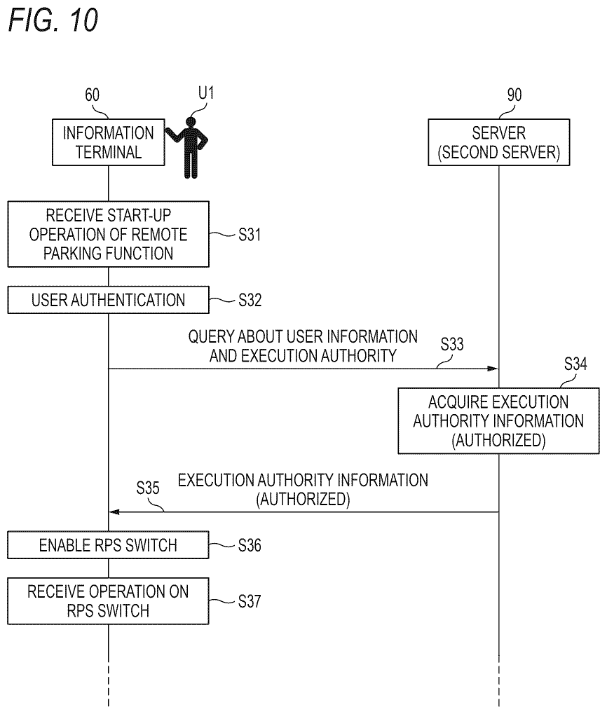

FIG. 10 is a sequence diagram showing an example of the second determination processing during the remote parking. First, as shown in FIG. 10, the information terminal 60 carried by the user U1 receives a start-up operation of a remote parking function (step S31). The start-up operation of the remote parking function is the second execution request for remote parking (second movement control) from the user U1, and is, for example, an operation of launching an application for instructing execution of the movement control of the vehicle 10 and tapping a “remote parking button”.

Next, the information terminal 60 executes the user authentication for the user U1 (step S32). For example, the user authentication may be implemented by inputting the user ID to the terminal screen 71 of the information terminal 60 or facial authentication through camera imaging. The information terminal 60 transmits, to the server 90 (second server), user information collected in the user authentication and a query about whether the user has the execution authority for the second movement control (step S33).

Upon receiving the query about the execution authority of the user U1, the server 90 acquires the execution authority information managed in association with the user ID, for example (step S34). In this example, it is assumed that the user U1 has the execution authority for the remote parking of the vehicle 10. The server 90 transmits, to the information terminal 60, the execution authority information indicating that the user U1 has the execution authority for the remote parking of the vehicle 10 (authorized) (step S35).

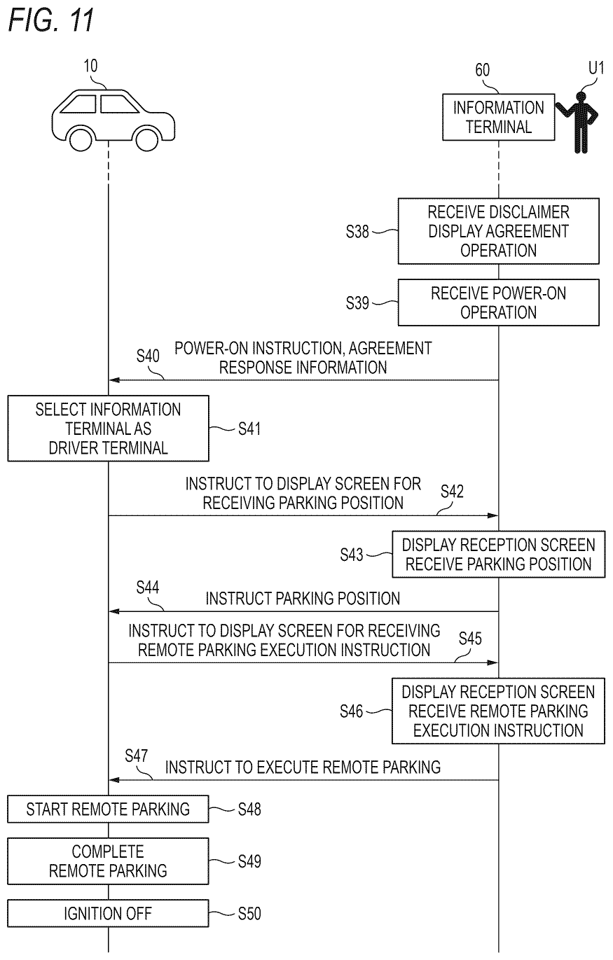

Upon receiving the execution authority information (authorized) from the server 90 in step S35, the information terminal 60 enables an “RPS switch” for receiving the execution instruction of the second movement control using the RPS, and lights and displays a button of the “RPS switch” on the touch panel 42, for example (step S36). When the user U1 touches the button of the “RPS switch” on the touch panel 42, the vehicle 10 receives the operation on the RPS switch (step S37) and proceeds to processing steps in FIG. 11.

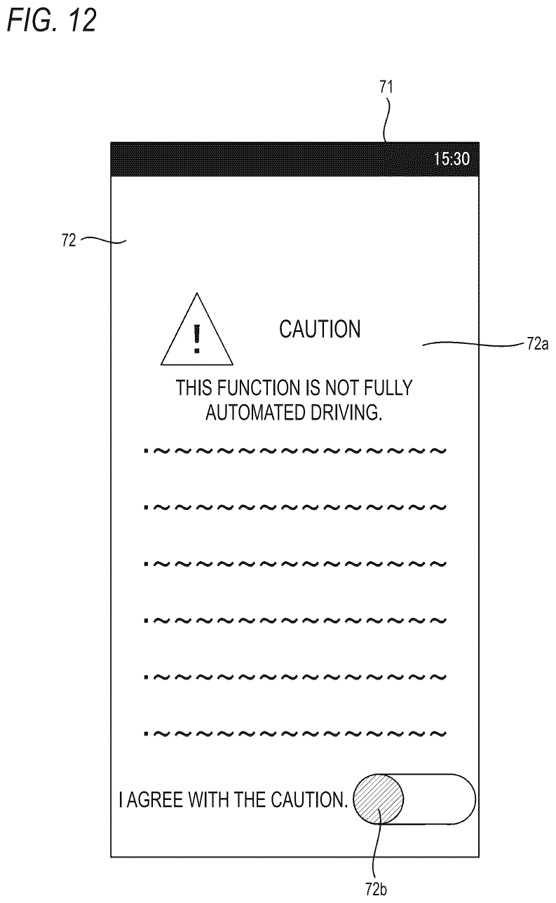

FIG. 11 is a sequence diagram showing an example of the remote parking control executed based on the result of the second determination processing. As described with reference to FIG. 10, when it is determined that the user U1 has the execution authority for the remote parking of the vehicle 10 and the operation on the RPS switch is received, the information terminal 60 displays a disclaimer (a specified caution related to the remote parking) on the terminal screen 71 and receives an agreement operation of the user U1 for agreeing with the disclaimer (step S38). A screen of the disclaimer will be described later with reference to FIG. 12.

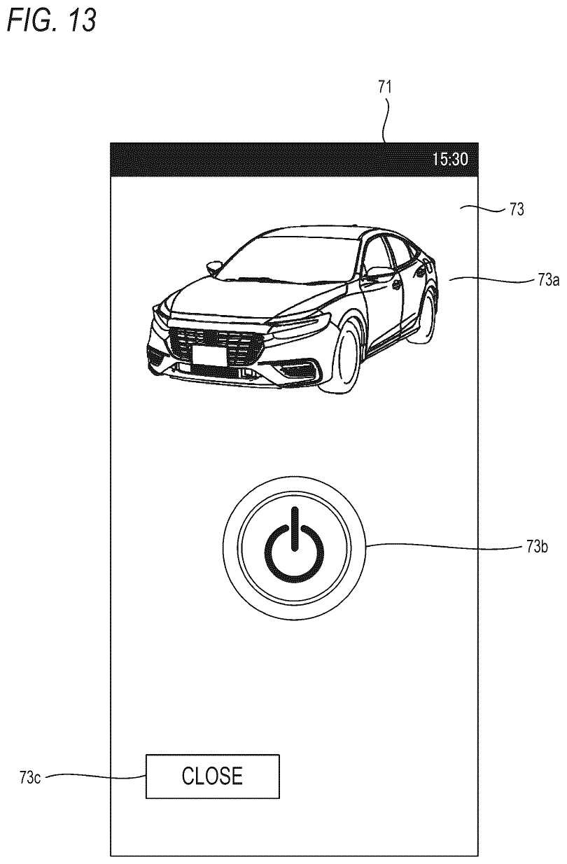

Next, after receiving the disclaimer agreement operation from the user U1, the information terminal 60 receives a power-on operation to start the vehicle 10 (step S39). A screen for receiving the power-on operation will be described later with reference to FIG. 13. The information terminal 60 transmits the power-on instruction received in step S39 and agreement response information of the disclaimer received in step S38 to the vehicle 10 (step S40).

The vehicle 10 selects the information terminal 60 that transmits the agreement response information as a driver terminal of the user U1 who has the execution authority (step S41). Accordingly, the information terminal 60 is in a state of being communicably connected to the vehicle 10 as the driver terminal that can instruct the remote parking of the vehicle 10. The vehicle 10 transmits a display instruction to the information terminal 60 selected as the driver terminal to display a reception screen for receiving a parking position instruction for the vehicle 10 (step S42).

When the display instruction is received from the vehicle 10, the information terminal 60 displays a parking position reception screen on the terminal screen 71 and receives the parking position instruction from the user U1 (step S43). Upon receiving the parking position instruction, the information terminal 60 transmits the received parking position instruction to the vehicle 10 (step S44).

When the parking position instruction is received from the information terminal 60, the vehicle 10 transmits, to the information terminal 60, a display instruction to display a reception screen for a remote parking execution instruction (step S45).

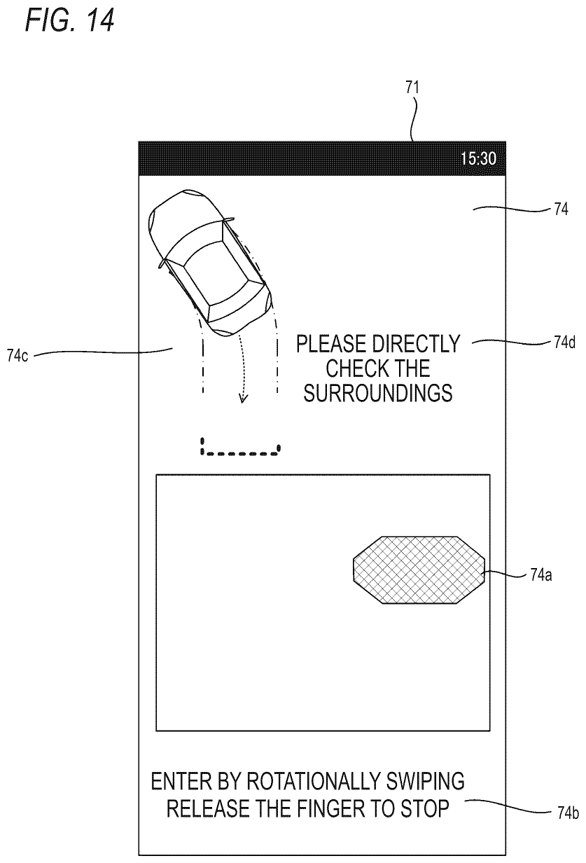

When the instruction to display the reception screen is received from the vehicle 10, the information terminal 60 displays the reception screen on the terminal screen 71 and receives the remote parking execution instruction from the user U1 (step S46). The reception screen for receiving the remote parking execution instruction will be described later with reference to FIG. 14. Upon receiving the remote parking execution instruction from the user U1, the information terminal 60 transmits, to the vehicle 10, the received remote parking execution instruction (step S47).

When the remote parking execution instruction is received from the information terminal 60, the vehicle 10 starts the remote parking of the vehicle 10 according to the execution instruction (step S48). When the remote parking is completed (step S49), the vehicle 10 turns off the ignition (step S50).

The user authentication in step S32 in FIG. 10 may be executed in advance, for example, when the information terminal 60 wakes from a sleep mode. In the second movement control in this example, the control for remotely parking the vehicle 10 has been described, but the second movement control is not limited thereto. For example, the second movement control may be control for remotely causing the vehicle 10 to exit. In the case of remote exiting, the ignition may not be turned off after the remote exiting is completed.

FIG. 12 shows an example of a disclaimer screen 72 displayed on the terminal screen 71 on the information terminal 60. The disclaimer screen 72 is a screen displayed when it is recognized that the user U1 has the execution authority for the remote parking of the vehicle 10. The disclaimer screen 72 is displayed, for example, in step S38 in FIG. 11.

As shown in FIG. 12, the disclaimer screen 72 includes an agreement sentence 72a indicating an agreement content such as “CAUTION: THIS FUNCTION IS NOT FULLY AUTONOMOUS DRIVING.” The disclaimer screen 72 also includes an agreement button 72b for the user U1 to operate when agreeing with the caution. Further, the disclaimer screen 72 includes a sentence such as “I agree with the caution.” indicating that the caution is agreed with, which is displayed when the agreement button 72b is swiped.

FIG. 13 shows an example of a power start-up screen 73 displayed on the terminal screen 71 on the information terminal 60. The power start-up screen 73 is a screen that is displayed when the disclaimer agreement operation from the user U1 is received. The power start-up screen 73 is displayed, for example, in step S39 in FIG. 11.

As shown in FIG. 13, the power start-up screen 73 includes, for example, a vehicle image 73a of the vehicle 10 and a power start-up button 73b for proceeding with the remote parking. The power start-up screen 73 also includes a close button 73c for closing the power start-up screen 73 when the remote parking is canceled.

FIG. 14 shows an example of an execution instruction reception screen 74 displayed on the terminal screen 71 on the information terminal 60. The execution instruction reception screen 74 is a screen displayed when the instruction to display the reception screen for receiving the remote parking execution instruction is received from the vehicle 10. The execution instruction reception screen 74 is displayed, for example, in step S46 in FIG. 11.

As shown in FIG. 14, the execution instruction reception screen 74 includes a moving icon 74a that moves following a touch position of the user U1 in a rotation swipe operation, for example. The execution instruction reception screen 74 also includes a guide message 74b for executing the remote parking of the vehicle 10 or temporarily stopping the remote parking of the vehicle 10, such as “ENTER BY ROTATIONALLY SWIPING” or “RELEASE THE FINGER TO STOP”. The moving icon 74a and the guide message 74b are an example of a guidance image for prompting the user U1 to issue the remote parking execution instruction. The execution instruction reception screen 74 also includes an execution state image 74c indicating an execution state (a state of movement of the vehicle) of the parking control for the vehicle 10 above an area in which the moving icon 74a is displayed. Further, the execution instruction reception screen 74 includes a caution message 74d, such as “PLEASE DIRECTLY CHECK THE SURROUNDINGS”, for example, on a right side of the execution state image 74c to alert the user U1 who performs the instruction operation. For example, the information terminal 60 transmits a remote parking movement instruction that instructs movement of the vehicle 10 when receiving the rotation swipe operation on the moving icon 74a, and transmits a remote parking stop instruction that instructs stop of the vehicle 10 when the rotation swipe operation on the moving icon 74a is stopped.

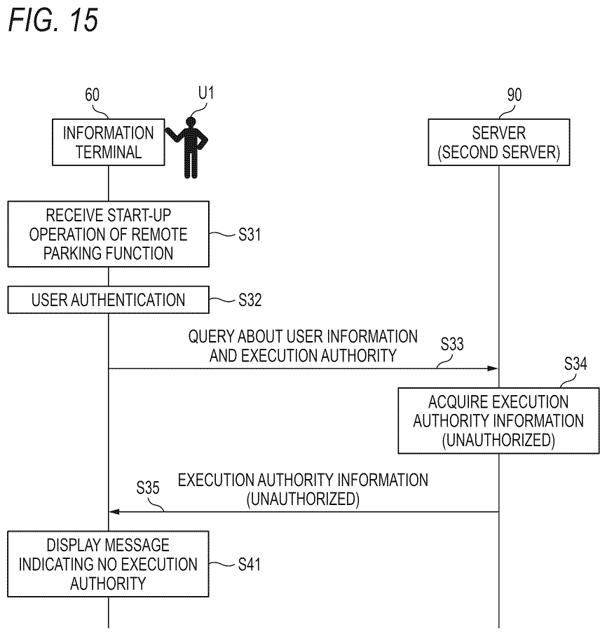

FIG. 15 is a sequence diagram showing a case where the user U1 does not have the execution authority for the remote parking in the second determination processing in FIG. 10. As shown in FIG. 15, the processing from step S31 to step S33 is the same as that from step S31 to step S33 described with reference to FIG. 10.

Upon receiving the query about the execution authority of the user U1, the server 90 acquires the execution authority information managed in association with the user ID (step S34). In this example, the user U1 does not have the execution authority for the remote parking of the vehicle 10 (unauthorized). The server 90 transmits, to the information terminal 60, the execution authority information indicating that the user U1 does not have the execution authority for the remote parking of the vehicle 10 (unauthorized) (step S35).

Upon receiving the execution authority information (unauthorized) from the server 90 in step S35, the information terminal 60 displays a message indicating that there is no execution authority on the terminal screen 71 (step S41).

In this example, the control is still not limited to the control of remotely parking the vehicle 10, and may be control of remotely causing the vehicle 10 to exit.

### Message During Second Movement Control

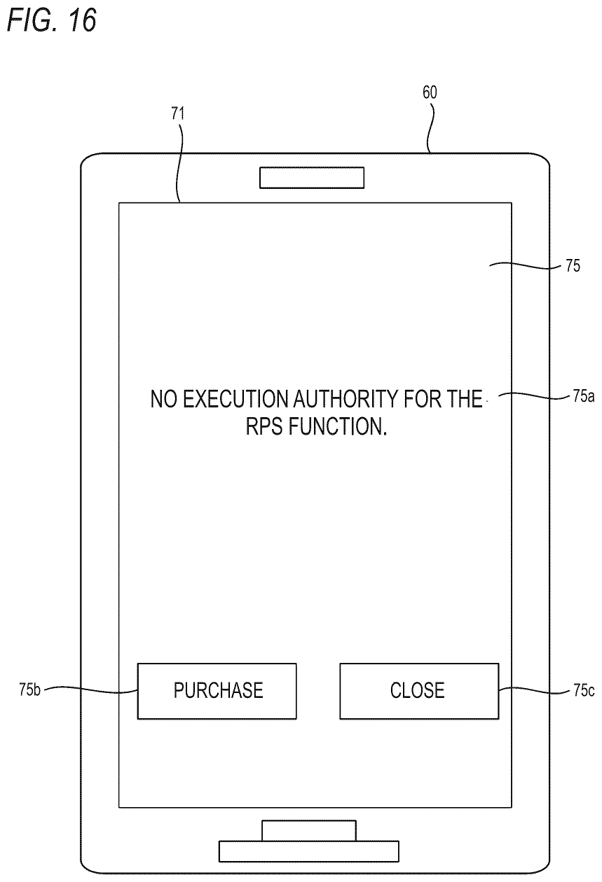

FIG. 16 shows an example of a message screen displayed during the second movement control. The message screen in this example is a screen displayed on the terminal screen 71 of the information terminal 60 when the user U1 does not have the execution authority for the remote parking in step S41 in the processing in FIG. 15.

As shown in FIG. 16, a message screen 75 displays an execution authority message 75a indicating that there is no execution authority, such as “NO EXECUTION AUTHORITY FOR THE RPS FUNCTION”. The message screen 75 also includes a “PURCHASE” button 75b for purchasing the execution authority for the RPS function online, and a “CLOSE” button 75c for stopping the present operation for remotely parking the vehicle 10.

As described above, in the control system 1 in the present embodiment, in the first movement control for moving the vehicle 10 in the state where the user U1 is present in the vehicle 10, the calculation unit 52 of the vehicle 10 executes the first determination processing for determining whether the user U1 has the execution authority for the first movement control, and in the second movement control for moving the vehicle 10 in the state where the user U1 is not present in the vehicle 10, the information terminal 60 carried by the user U1 executes the second determination processing for determining whether the user U1 has the execution authority for the second movement control without going through the calculation unit 52 of the vehicle 10. Therefore, even in the state where the user U1 is not present in the vehicle 10, it is possible to execute the processing of determining whether the user U1 has the execution authority related to the vehicle 10. Accordingly, as compared to a configuration in which the information terminal 60 executes the execution authority determination processing via the calculation unit 52 of the vehicle 10, for example, it is possible to shorten a response time when executing the determination processing and prevent leakage of personal information of the user. Therefore, it is possible to appropriately determine the execution authority of the user U1 for a target function of the vehicle 10.

The control method described in the above embodiment may be implemented by executing a control program prepared in advance on a computer. The control program is stored in a computer-readable storage medium and executed by being read from the storage medium. In addition, the control program may be provided in a form stored in a non-transitory storage medium such as a flash memory, or may be provided via a network such as the Internet. The computer that executes the present control program may be provided in the control device and the information terminal, may be provided in an electronic device such as a smartphone, a tablet terminal, or a personal computer that can communicate with the control device and the information terminal, or may be provided in a server device that can communicate with the control device, the information terminal, and the electronic device.

Although the embodiment of the present disclosure has been described above, the present disclosure is not limited to the above-described embodiment, and modifications, improvements, and the like may be appropriately made.

In the above-described embodiment, an example in which the moving object is a vehicle (four-wheeled automobile) has been described, but the moving object is not limited thereto. For example, the moving object may be a vehicle such as a two-wheeled vehicle or a Segway. Further, the idea of the present disclosure is not limited to the vehicle, and may also be applied to a robot, a ship, an aircraft, or the like that includes a drive source and is movable by power of the drive source.

In the present specification, at least the following matters are described. In the parentheses, the corresponding constituent elements and the like in the above embodiment are shown, but the present disclosure is not limited thereto.

(1) A control system (control system 1) including:
a control device (calculation unit 52) provided in a moving object (vehicle 10); and
an information terminal (information terminal 60) carried by a user of the moving object, in which
the control device includes
   a first movement control unit (first movement control unit 55) that executes first movement control for moving the moving object in a state where the user is present in the moving object, and
   a second movement control unit (second movement control unit 56) that executes second movement control for moving the moving object in a state where the user is not present in the moving object,
when a request to execute the first movement control is received from the user, the first movement control unit executes first determination processing for determining execution authority of the user for the first movement control, and executes the first movement control based on a result of the first determination processing, and
when a request to execute the second movement control is received from the user, the information terminal executes second determination processing for determining execution authority of the user for the second movement control, and causes the control device to execute the second movement control based on a result of the second determination processing.

According to (1), in the second movement control for moving the moving object in the state where the user is not present in the moving object, the information terminal carried by the user executes the processing of determining the execution authority without going through the control device of the moving object, thus the processing of determining the execution authority can be performed even in the state where the user is not present in the moving object, and a response time can be reduced whereas leakage of personal information can be prevented as compared to a configuration in which the information terminal executes the processing of determining the execution authority via the control device of the moving object. Accordingly, it is possible to appropriately determine the execution authority of the user for a target function of the moving object.

(2) The control system according to (1), in which
the control device
   includes a first input unit (first input unit 58) where an execution instruction of the first movement control is receivable, and
   controls the first input unit to a state where the execution instruction of the first movement control is received when the execution authority of the user for the first movement control is determined to be valid by the first determination processing, and
the information terminal
   includes a second input unit (terminal screen 71) where an execution instruction of the second movement control is receivable, and
   controls the second input unit to a state where the execution instruction of the second movement control is received when the execution authority of the user for the second movement control is determined to be valid by the second determination processing.

According to (2), when it is determined that the execution authority of the user for the second movement control is valid, the second input unit is in the state where the execution instruction of the second movement control is received without going through the control device of the moving object, thus the information terminal can receive the execution authority even in the state where the user is not present in the moving object, and the response time can be shortened whereas the leakage of the personal information can be prevented as compared to the configuration in which the information terminal receives the execution authority via the control device of the moving object. Accordingly, it is possible to appropriately determine the execution authority of the user for the target function of the moving object.

(3) The control system according to (2), in which
when the execution authority of the user for the first movement control is not determined to be valid by the first determination processing, the control device controls the first input unit to a state where the execution instruction of the first movement control is not received, and
when the execution authority of the user for the second movement control is not determined to be valid by the second determination processing, the information terminal controls the second input unit to a state where the execution instruction of the second movement control is not received.

According to (3), when the execution authority of the user for the second movement control is not determined to be valid, the second input unit is in the state where the execution instruction of the second movement control is not received, thus the information terminal can recognize that the execution authority is not received even in the state where the user is not present in the moving object, and the response time can be shortened whereas the leakage of the personal information can be prevented as compared to the configuration in which the information terminal receives the execution authority via the control device of the moving object. Accordingly, it is possible to appropriately determine the execution authority of the user for the target function of the moving object.

(4) The control system according to any one of (1) to (3), in which
the control device includes a first communication unit (first communication unit 57) communicable with a first server, and executes the first determination processing by querying the first server via the first communication unit, and
the information terminal includes a second communication unit (processor 61 and communication interface 63) communicable with a second server that is the same as or different from the first server, and executes the second determination processing by querying the second server via the second communication unit.

As in (4), the information terminal queries the second server via the second communication unit without going through the control device of the moving object to execute the second determination processing, thus the determination processing of the execution authority can be executed even in the state where the user is not present in the moving object, and the response time can be reduced whereas the leakage of the personal information can be prevented as compared to a configuration in which the information terminal executes the processing of determining the execution authority via the control device of the moving object. Accordingly, it is possible to appropriately determine the execution authority of the user for the target function of the moving object.

(5) The control system according to (4), in which
the information terminal
   includes a storage unit (memory 62) that stores a result of the second determination processing in a past time, and
   causes the control device to execute the second movement control based on the result of the second determination processing stored in the storage unit when communication with the second server is not available.

According to (5), when communication with the second server is not available, the information terminal executes the processing of determining the execution authority based on the result of the second determination processing stored in the storage unit without going through the control device of the moving object, thus the process of determining the execution authority can be executed even in a state where a communication environment is poor when the user is not present in the moving object, and the response time can be shortened whereas the leakage of the personal information can be prevented as compared to the configuration in which the information terminal executes the processing of determining the execution authority via the control device of the moving object. Accordingly, it is possible to appropriately determine the execution authority of the user for the target function of the moving object.

(6) A control method in a control system that includes a control device provided in a moving object and an information terminal carried by a user of the moving object, in which
the control device includes
   a first movement control unit that executes first movement control for moving the moving object in a state where the user is present in the moving object, and
   a second movement control unit that executes second movement control for moving the moving object in a state where the user is not present in the moving object, and
the control method includes:
   causing, when a request to execute the first movement control is received from the user, the first movement control unit to execute first determination processing for determining execution authority of the user for the first movement control and to execute the first movement control based on a result of the first determination processing; and
   causing, when a request to execute the second movement control is received from the user, the information terminal to execute second determination processing for determining execution authority of the user for the second movement control and to cause the control device to execute the second movement control based on a result of the second determination processing.

According to (6), in the second movement control for moving the moving object in the state where the user is not present in the moving object, the information terminal carried by the user executes the processing of determining the execution authority without going through the control device of the moving object, thus the processing of determining the execution authority can be performed even in the state where the user is not present in the moving object, and the response time can be reduced whereas the leakage of personal information can be prevented as compared to the configuration in which the information terminal executes the processing of determining the execution authority via the control device of the moving object. Accordingly, it is possible to appropriately determine the execution authority of the user for the target function of the moving object.

1. A control system comprising:
a control device provided in a moving object; and
an information terminal carriable by a user of the moving object, wherein the control device includes:
a first movement controller configured to execute first movement control for moving the moving object in a state where the user is present in the moving object; and
a second movement controller configured to second movement control for moving the moving object in a state where the user is not present in the moving object,
in response to a request to execute the first movement control from the user, the first movement controller executes first determination processing for determining execution authority of the user for the first movement control, and executes the first movement control based on a result of the first determination processing, and
in response to a request to execute the second movement control from the user, the information terminal executes second determination processing for determining execution authority of the user for the second movement control, and causes the control device to execute the second movement control based on a result of the second determination processing.

2. The control system according to claim 1, wherein
the control device includes a first input circuit in which an execution instruction of the first movement control is receivable,
the control device enables the first input circuit to receive the execution instruction of the first movement control, when the execution authority of the user for the first movement control is determined to be valid by the first determination processing,
the information terminal includes a second input circuit in which an execution instruction of the second movement control is receivable, and
the control device enables the second input circuit to receive the execution instruction of the second movement control, when the execution authority of the user for the second movement control is determined to be valid by the second determination processing.

3. The control system according to claim 2, wherein
when the execution authority of the user for the first movement control is not determined to be valid by the first determination processing, the control device does not enable the first input circuit to receive the execution instruction of the first movement control, and
when the execution authority of the user for the second movement control is not determined to be valid by the second determination processing, the information terminal does not enable the second input circuit to receive the execution instruction of the second movement control.

4. The control system according to claim 1, wherein
the control device includes a first communication circuit communicable with a first server, and executes the first determination processing by querying the first server via the first communication circuit, and
the information terminal includes a second communication circuit communicable with a second server that is the same as or different from the first server, and executes the second determination processing by querying the second server via the second communication circuit.

5. The control system according to claim 4, wherein
the information terminal includes a storage that stores a result of the second determination processing in a past time, and
the information terminal causes the control device to execute the second movement control based on the result of the second determination processing stored in the storage when communication with the second server is not available.

6. A control method in a control system that includes a control device provided in a moving object and an information terminal carriable by a user of the moving object, wherein
the control device includes:
a first movement controller that executes first movement control for moving the moving object in a state where the user is present in the moving object; and
a second movement controller that executes second movement control for moving the moving object in a state where the user is not present in the moving object, and
the control method comprises:
causing, when a request to execute the first movement control is received from the user, the first movement controller to execute first determination processing for determining execution authority of the user for the first movement control and to execute the first movement control based on a result of the first determination processing; and
causing, when a request to execute the second movement control is received from the user, the information terminal to execute second determination processing for determining execution authority of the user for the second movement control and to cause the control device to execute the second movement control based on a result of the second determination processing.
